(19) United States
(12) Patent Application Publication
(10) Pub. No.: US 2023/0034141 A1
(43) Pub. Date: Feb. 2, 2023

(54) BINDER COMPOSITION INCLUDING BIO-BASED COMPONENT

(71) Applicant: CARGILL, INCORPORATED, Wayzata, MN (US)

(72) Inventors: Todd L. KURTH, Maple Grove, MN (US); Anthony Joseph SYLVESTER, Minneapolis, MN (US); Hassan Ali TABATABAEE, Plymouth, MN (US)

(73) Assignee: CARGILL, INCORPORATED, Wayzata, MN (US)

(21) Appl. No.: 17/756,130

(22) PCT Filed: Nov. 19, 2020
(86) PCT No.: PCT/US2020/061313

§ 371 Date: May 18, 2022

Related U.S. Application Data
(60) Provisional application No. 62/938,182, filed on Nov. 20, 2019.

(51) Int. Cl. C08K 5/45; C08K 5/00; E04D 1/20

(52) U.S. Cl. CPC C08K 5/45; C08K 5/0025; E04D 1/20

(57) ABSTRACT

Various aspects relate to binder compositions including a bio-based component and pre-blends for forming the same. A binder composition includes an oligomerized biorenewable oil that is at least 10 wt % of the binder composition. The binder composition also includes an Asphaltene Additive comprising at least 20 wt % to 100 wt % asphaltenes, wherein the Asphaltene Additive is at least 8 wt % of the binder composition.

### BACKGROUND

Bitumen or asphalt is typically derived from a petroleum-based material used for various applications including the binder phase for roofing shingles and asphalt concrete, also called blacktop or asphalt pavement. Due to concerns including declining sources of petroleum-based materials and increasing prices thereof, pollution, and climate change, binder compositions including non-petroleum-derived materials are appealing.

### SUMMARY OF THE INVENTION

In various aspects, the present invention provides a binder composition. The binder composition includes an oligomerized biorenewable oil that is at least 10 wt % of the binder composition. The binder composition also includes an Asphaltene Additive including at least 20 wt % to 100 wt % asphaltenes, wherein the Asphaltene Additive is at least 8 wt % of the binder composition.

In various aspects, the present invention provides a binder composition. The binder composition includes an oligomerized biorenewable oil that is oligomerized via sulfurization and that is 20 wt % to 45 wt % of the binder composition, wherein oligomer molecules are for example, at least 10 wt % for example, at least 20 wt %, at least 30 wt %, at least 40 wt %, at least 50 wt %, for example, at least 60 wt % of the oligomerized biorenewable oil. The binder composition includes an Asphaltene Additive that is gilsonite, wherein the Asphaltene Additive is 10 wt % to 45 wt % of the binder composition. The binder composition also includes bitumen in addition to any bitumen included in the Asphaltene Additive that is 15 wt % to 90 wt % of the binder composition.

In various aspects, the present invention provides an asphalt emulsion. The asphalt emulsion includes a binder composition. The binder composition includes an oligomerized biorenewable oil that is at least 10 wt % of the binder composition. The binder composition also includes an Asphaltene Additive including at least 20 wt % to 100 wt % asphaltenes, wherein the Asphaltene Additive is at least 8 wt % of the binder composition. The asphalt emulsion also includes water that is emulsified with the binder composition.

In various aspects, the present invention provides an asphalt pavement. The asphalt pavement includes a binder composition. The binder composition includes an oligomerized biorenewable oil that is at least 10 wt % of the binder composition. The binder composition also includes an Asphaltene Additive including at least 20 wt % to 100 wt % asphaltenes, wherein the Asphaltene Additive is at least 8 wt % of the binder composition. The asphalt pavement also includes aggregate blended with the binder composition. In some aspects, the asphalt pavement includes a recycled asphalt pavement, wherein the bitumen in the binder composition includes recycled or aged bitumen, the aggregate includes aggregate from a recycled asphalt composition, or a combination thereof.

In various aspects, the present invention provides a roofing shingle. The roofing shingle includes a binder composition. The binder composition includes an oligomerized biorenewable oil that is at least 10 wt % of the binder composition. The binder composition also includes an Asphaltene Additive including at least 20 wt % to 100 wt % asphaltenes, wherein the Asphaltene Additive is at least 8 wt % of the binder composition. The roofing shingle also includes a base material.

In various aspects, the present invention provides a method of making a binder composition. The method includes forming the binder composition, the binder composition including an oligomerized biorenewable oil that is at least 10 wt % of the binder composition; an Asphaltene Additive including at least 20 wt % to 100 wt % asphaltenes, wherein the Asphaltene Additive is at least 8 wt % of the binder composition; and bitumen in addition to any bitumen included in the Asphaltene Additive.

In various aspects, the present invention provides a method of making an asphalt emulsion. The method including emulsifying a binder composition and an aqueous phase (e.g., water). The binder composition includes an oligomerized biorenewable oil that is at least 10 wt % of the binder composition. The binder composition also includes an Asphaltene Additive including at least 20 wt % to 100 wt % asphaltenes, wherein the Asphaltene Additive is at least 8 wt % of the binder composition.

In various aspects, the present invention provides a method of making an asphalt pavement. The method includes combining a binder composition with an aggregate. The binder composition includes an oligomerized biorenewable oil that is at least 10 wt % of the binder composition. The binder composition also includes an Asphaltene Additive including at least 20 wt % to 100 wt % asphaltenes, wherein the Asphaltene Additive is at least 8 wt % of the binder composition. In some aspects, the asphalt pavement can include a recycled asphalt pavement, wherein the bitumen in the binder composition includes recycled or aged bitumen, the aggregate includes aggregate from a recycled asphalt composition, or a combination thereof.

In various aspects, the present invention provides a method of making an asphalt pavement. The method includes combining an aggregate and a binder composition. The binder composition includes an oligomerized biorenewable oil that is oligomerized via sulfurization and that is 20 wt % to 45 wt % of the binder composition, wherein oligomer molecules, for example, are at least 10 wt %, at least 20 wt %, at least 30 wt %, at least 40 wt %, at least 50 wt %, or at least 60 wt % of the oligomerized biorenewable oil. The binder composition includes an Asphaltene Additive that is gilsonite, wherein the Asphaltene Additive is 10 wt % to 45 wt % of the binder composition. The binder composition also includes bitumen in addition to any bitumen included in the gilsonite that is 15 wt % to 90 wt % of the binder composition. In some aspects, the asphalt pavement can include a recycled asphalt pavement, wherein the bitumen in the binder composition includes recycled or aged bitumen, the aggregate includes aggregate from a recycled asphalt composition, or a combination thereof.

In various aspects, the present invention provides a method of making a roofing shingle. The method includes combining a binder composition with a base material. The binder composition includes an oligomerized biorenewable oil that is at least 10 wt % of the binder composition. The binder composition also includes an Asphaltene Additive including at least 20 wt % to 100 wt % asphaltenes, wherein the Asphaltene Additive is at least 8 wt % of the binder composition.

Various aspects of the present invention have certain advantages over other binder compositions, asphalt emulsions, asphalt pavements, roofing shingles, and methods of making the same, at least some of which are unexpected. For example, in various aspects, the binder composition has a retained or improved rheological profile, thermal stability, oxidative stability, and/or adhesion relative to corresponding petroleum-based bitumen compositions that are free of the oligomerized biorenewable oil. In various aspects, the binder composition of the present invention can provide very large performance grade useful temperature intervals and premium desirable performance grades, without compromising on thermal and oxidative stability, and while maintaining or improving on the iTc value, as a measure of binder compatibility and durability. In various aspects, the binder composition of the present invention can offer a uniquely high content of biorenewable or non-petroleum-based binder, offsetting or replacing fossil-based bitumen. In various aspects, the binder compositions incorporate higher than typical amounts of asphaltene-rich material, which is often considered an undesirable byproduct that cannot be used to form useful binder compositions. In various aspects, the binder composition of the present invention can provide unique alternatives in terms of biorenewable content and rheological and aging performance for paving, roofing, and industrial applications.

In various aspects, the binder composition of the present invention can be formed by blending a mixture including bitumen and the oligomerized biorenewable oil with the Asphaltene Additive at lower mixing temperatures, shorter times, or a combination thereof, as compared to other blending processes that combine the Asphaltene Additive with bitumen. In various aspects, by pre-blending the Asphaltene Additive with the oligomerized biorenewable oil, a higher content of the Asphaltene Additive can be incorporated into the bitumen than is typically used. In various aspects, the oligomerized biorenewable oil of the binder composition of the present invention allows for incorporation of higher-than-typical amounts of polymer modifiers or acid modifiers, which can provide exceptional elasticity and toughness.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

As used herein, the term “polymer” refers to a molecule having at least one repeating unit in the backbone of the polymer (e.g., at least one monomer that repeats in the backbone of the polymer) and can include copolymers.

As used herein, “asphalt”, and “asphalt binder”, and “bitumen” refer to the binder phase of an asphalt pavement. The binder can include binder material acquired from asphalt producing refineries, flux, refinery vacuum tower bottoms, pitch, and other residues of processing of vacuum tower bottoms, as well as oxidized and aged asphalt binder from recycled asphalt compositions such as reclaimed asphalt pavement (RAP), and recycled asphalt shingles (RAS). Asphalt or bitumen may also be from naturally occurring sources such as “lake asphalt”. Without being bound to any particular theory, the following description of the chemical structure of conventional asphalt is provided. Asphalt or bitumen includes a complex continuum of compounds covering spectrums of molecular weights, functionality, polarity, and heteroatom content. As a result, asphalt or bitumen is often conveniently fractionated in terms of reactivity and solubility using a predetermined set of solvents. Researchers have described the interactions between the defined fractions using a number of models such as the colloidal model. In the colloidal model a medium or continuous phase is defined as mainly including relatively low polarity naphthenic-aromatic compounds (or “solvent phase”) and paraffinic compounds that may include crystalline fractions. A dispersion of highly polar micelles at various levels of intermolecular association in the continuous medium provides much of the mechanical and rheological properties of the asphalt or bitumen. The constituents of the micelles are often defined as a high polarity and high molecular weight “asphaltene” fraction surrounded by a lower polarity “resin” (also known as “polar aromatic”) fractions with high affinity for both the neutral aromatic fraction and the polar asphaltene fraction.

Asphalt “ages” through a combination of mechanisms, mainly oxidation and volatilization. Aging increases asphalt modulus, decreases viscous dissipation and stress relaxation, and increases brittleness at lower performance temperatures. As a result, the asphalt becomes more susceptible to cracking and damage accumulation.

As used herein, “asphalt concrete” or “asphalt pavement” refers to a blend including asphalt binder and aggregate. An asphalt concrete or pavement can be a recycled asphalt concrete, such as wherein the bitumen in the binder includes recycled or aged bitumen, the aggregate includes aggregate from a recycled asphalt composition, or a combination thereof.

As used herein, “asphaltene” is a substance primarily including carbon and hydrogen, including multiple naphthenic and aromatic ring structures, and further including heteroatoms and functional groups primarily based on sulfur, nitrogen, and oxygen. Asphaltene can be the n-heptane-insoluble component of carbonaceous material, such as defined in ASTM D3279. In bitumen or asphalt, asphaltene is generally the largest molecular weight and highest density component of the four “SARA” fractions (saturates, aromatics, resins, asphaltenes) and includes the most polar moieties. The other three fractions (the n-heptane-soluble fractions) are collectively referred to as the “maltene” phase and can be defined using an Iatroscan MK-6S thin-layer chromatography method through adaption of the principles laid out in ASTM D4142 for fractionation of bitumen, using a n-pentane to elute the “saturates” and a 90:10 blend of toluene and chloroform to elute the “cyclic” or “aromatic” fraction. Data can be interpreted through assignment of the peak area in the retention time range (stated as the fraction of the entire rod scan time) of 0.01-0.250 to the “saturates”, “0.251-0.400 to the “cyclics”, and the remainder (0.401-0.510) to the “resin” fraction. Asphaltene is often a constituent of the vacuum tower residue resulting from the refining of crude oils, especially heavier crudes. Certain processes in the crude oil refining process can result in substances that are especially rich in asphaltene, such as solvent de-asphalting pitch or residuum oil supercritical extraction process (ROSE®) pitch. Naturally occurring substances rich in asphaltene substances can be from sources that include “gilsonite” or “uintahite”, commonly mined from deposits in the Uintah Basin in Utah, and Trinidad lake asphalt (TLA).

As used herein, “aggregate” refers to the rock phase of an asphalt pavement. In the asphalt pavement, the aggregate is bound together by a binder. The aggregate can be material acquired from RAP and RAS sources and/or can be virgin material not previously used in asphalt applications.

As used herein, “recycled asphalt” or “recycled bitumen” includes RAP, RAS, or asphalt resulting from a solvent de-asphalting process. A recycled asphalt or recycled bitumen can include aggregate that includes recycled materials, such as aggregate derived from a recycled or aged asphalt composition. The source of the recycled asphalt or recycled bitumen can include asphalt pavement, asphalt shingles, roofing membranes, asphaltic coatings, or other bitumen-containing formulations. A recycled asphalt or recycled bitumen can include binder that includes recycled materials, such as recycled or aged bitumen. Such recycled asphalt content can include that which is being recycled for the first time and/or that which has been recycled multiple times.

As used herein, “oligomer” is a polymer molecule having a molecular weight larger than 400. In contrast, a monomer can include monoacylgyclerides (MAG), diacylglycerides (DAG), triacylglycerides (TAG), and free fatty acids (FFA).

As used herein, a “oligomerized biorenewable oil” includes one or more biorenewable oils that have been oligomerized via sulfurization, bodying, blowing, or a combination thereof. An oligomerized biorenewable oil of the current invention typically has a number average molecular weight of at least 800, preferably at least 1000, for example, at least 1200, and preferably between 1200 and 1750.

### Binder Composition.

In various aspects, the present invention provides a binder composition. The binder composition can include bitumen in addition to any bitumen included in the Asphaltene Additive, or the binder composition can be substantially free of bitumen other than any bitumen included in the Asphaltene Additive. The binder composition can include an oligomerized biorenewable oil that is at least 10 wt % of the binder composition. The binder composition can also include an Asphaltene Additive including at least 20 wt % to 100 wt % asphaltenes, wherein the Asphaltene Additive is at least 8 wt % of the binder composition. The binder composition can partially or complete replace the asphalt binder that is combined with an aggregate to form asphalt pavement. The binder composition itself is substantially free of aggregate (e.g., includes about 0 wt % aggregate). The binder composition can be referred to as an “asphalt”, an “asphalt composition”, or an “asphalt binder composition”, even for embodiments of the binder composition that are substantially free of bitumen. A composition including a combination of the binder composition and aggregate can be referred to as an “asphalt pavement” or “asphalt concrete”, even for embodiments of the binder composition that are substantially free of bitumen.

The binder composition can be utilized in an asphalt mixture for road applications, including asphalt pavements, pothole repair mixes, cold mixes, warm mixes, and hot recycled mixes. The binder composition can be utilized in pavement preservation applications, especially those typically using bitumen, such as crack sealants, joint sealers, chip seals, fog seals, scrub seals, slurry seals, rejuvenating seals, and micro-surfacing, in which the binder composition may or may not be emulsified. The binder composition can be utilized for construction purposes such as tack coats, prime coats, and cold recycling, in which the binder composition may or may not be emulsified. The binder composition can be utilized in various roofing applications in which bitumen may be used. This may include shingles, roofing mats, built-up roofing, and the like. The binder composition can be utilized in coating applications, especially those that may utilize bitumen, including but not limited to corrosion inhibitors, paints, waterproofing, fertilizer coating, pipe coatings, and other industrial coating applications.

The Asphaltene Additive is any suitable one or more additives that includes at least 20 wt % to 100 wt % asphaltenes, 30 wt % to 90 wt %, 50 wt % to 80 wt % asphaltenes, or 20 wt % or more, or less than, equal to, or greater than 25 wt %, 30, 35, 40, 45, 50, 52, 54, 56, 58, 60, 62, 64, 66, 68, 70, 72, 74, 76, 78, 80, or 85 wt %, or 90 wt % asphaltenes or less, or less than 90 wt % asphaltenes, 85, 80, or less than 75 wt % asphaltenes in the Asphaltene Additive. Asphaltene Additives are substantially free of low molecular weight and low polarity naphthenic and aromatic molecules and of a saturates fraction. Low molecular weight and low polarity naphthenic and aromatic molecules and the saturates fraction are about 0 wt % to about 40 wt % of the Asphaltene Additive, preferably less than 35 wt %, more preferably less than 30 wt % of the Asphaltene Additive, or about 0 wt % to about 50 wt % of the Asphaltene Additive, 0 wt % to 40 wt %, 0 wt % to wt %, 0 wt % to 5 wt %, wt % to 3 wt %, 0 wt % to 1 wt %, 0 wt % to 0.5 wt %, 0 wt % to 0.1 wt %, or 0 wt % or more, or less than, equal to, or greater than 0.0001 wt %, 0.001, 0.01, 0.1, 0.5, 1, 1.5, 2, 2.5, 3, 4, 5, 6, 7, 8, 9, 10, 12, 14, 16, 18, 20, 22, 24, 26, 28, 30, 35 wt %, or 40 wt % or less. In contrast, bitumen generally has a significant concentration of lower molecular weight and low polarity naphthenic and aromatic molecules, and a significant amount of a saturates fraction. Preferably, the Asphaltene Additive can be gilsonite, uintahite, residuum oil supercritical extract, or a combination thereof. More preferably, the Asphaltene Additive can include or can be gilsonite. The Asphaltene Additive can form any suitable proportion of the binder composition, such as at least 10 wt % of the binder composition, 8 wt % to 60 wt % of the binder composition, 10 wt % to 45 wt %, 8 wt % or more, or less than, equal to, or greater than 10 wt %, 12, 14, 16, 18, 20, 22, 24, 26, 28, 30, 32, 34, 36, 38, 40, 42, 44, 45, 50, or 55 wt %, or 60 wt % of the binder composition or less.

The total asphaltene content of the binder composition can be at least 1 wt %, 2, 3, 4, 5, 8, 10, 12, 15, 20 wt %, 30, 40, or at least 50%, or 1 wt % to 70 wt %, 2 wt % to 60 wt %, or 3 wt % to 50 wt %, or 1 wt % or more, or less than, equal to, or greater than 2 wt %, 3, 4, 5, 6, 8, 10, 12, 14, 16, 18, 20, 22, 24, 26, 28, 30, 35, 40, 45, 50, 55, 60, 65 wt %, or about 70 wt % or less.

In binder compositions that include bitumen in addition to any bitumen included in the Asphaltene Additive, the bitumen can be any suitable bitumen. The bitumen can include or can be virgin bitumen. The bitumen can include or can be a recycled bitumen, such that the binder composition is a recycled binder composition. Recycled bitumen can be bitumen obtained from RAP or RAS, a bitumen-type material obtained via a solvent de-asphalting process, such as propane-precipitated bitumen derived from the bottoms of a solvent de-asphalting process, or a combination thereof. The bitumen can form any suitable proportion of the binder composition, such as 0 wt % of the binder composition, 10 wt % to 90 wt %, 15 wt % to 90 wt %, 60 wt % to 90 wt %, 15 wt % to 40 wt %, 10 wt % to 15 wt %, or 0 wt % or more, or less than, equal to, or greater than 1 wt %, 2, 4, 6, 8, 10, 12, 14, 15 wt %, 20, 25, 30, 35, 40, 45, 50, 55, 60, 65, 70, 75, 80, or 85 wt %, or 90 wt % or less.

The biorenewable oil can be any suitable biorenewable oil, such as an animal-based oil, an algae-based oil, a plant-based oil, or a combination thereof. Animal-based oils can be any suitable oil extracted or derived from an animal source, such animal fat (e.g., lard, tallow), lecithin (phospholipids), and combinations and crude streams thereof. Algae-based oils can be any suitable oil extracted or derived from an algae source. Plant-based oils can be any suitable plant-based oil. Plant-based oils can include soybean oil, linseed oil, canola oil, rapeseed oil, castor oil, tall oil, cottonseed oil, sunflower oil, palm oil, peanut oil, safflower oil, corn oil, corn stillage oil, lecithin (phospholipids) and combinations, distillates, derivatives, and crude streams thereof. A plant-based oil can be a vegetable oil. Plant-based oils can include partially hydrogenated oils, oils with conjugated bonds, or bodied oils wherein a heteroatom is not introduced, for example, diacylglycerides, monoacylglycerides, or free fatty acids (and distillate streams thereof), alkyl esters of fatty acids (e.g. methyl, ethyl, propyl, and butyl esters), and mixtures and derivative streams thereof. An example of plant-based oils can include waste cooking oil or other used oils. In contrast, petroleum-based oil includes a broad range of hydrocarbon-based compositions and refined petroleum products, having a variety of different chemical compositions which are obtained from recovery and refining oils of fossil-based origin and are considered non-renewable in that it takes millions of years to generate crude starting material.

The oligomerized biorenewable oil includes one or more biorenewable oils that have been oligomerized via sulfurization, bodying, blowing, or a combination thereof. In some aspects, the oligomerized biorenewable oil has not been blended with any non-oligomerized oil (e.g., any non-oligomerized biorenewable oil) after oligomerization. In other aspects, the oligomerized biorenewable oil has been blended with a non-oligomerized biorenewable oil after oligomerization. Oligomer molecules (e.g., oligomerized biorenewable oil molecules) can be any suitable proportion of the oligomerized biorenewable oil, such as 5 wt % to 100 wt % of the oligomerized biorenewable oil, 65 wt % to 75 wt % of the oligomerized biorenewable oil, or 5 wt % or more, or less than, equal to, or greater than 10 wt %, 15, 20, 25, 30, 35, 40, 45, 50, 55, 60, 62, 64, 65, 66, 68, 70, 72, 74, 75, 76, 78, 80, 85, 90, or 95 wt %, or 100 wt % or less. The oligomerized biorenewable oil can be any suitable proportion of the binder composition, such as 10 wt % to 80 wt % of the binder composition, 10 wt % to 60 wt %, 20 wt % to 45 wt %, or at least 10 wt %, at least 15 wt %, at least 20 wt %, at least 40 wt %, at least 50 wt %, or 10 wt % or less, or less than, equal to, or greater than 12 wt %, 15, 20, 22, 24, 26, 28, 30, 32, 34, 36, 38, 40, 42, 44, 45, 46, 48, 50, 55, 60, 65, 70, or 75 wt %, or 80 wt % more.

The oligomerized biorenewable oil can include a modified or functionalized biorenewable oil. Examples of previously modified oils are those that have been previously vulcanized or oligomerized by other oligomerizing technologies, such as maleic anhydride or acrylic acid modified, hydrogenated, dicyclopentadiene modified, conjugated via reaction with iodine, interesterified, or processed to modify acid value, hydroxyl number, or other properties. Such modified oils can be blended with unmodified biorenewable oils or animal-based oils, fatty acids, glycerin, and/or lecithin. Examples of functionalized oils are those wherein a heteroatom (oxygen, nitrogen, sulfur, and phosphorus) has been introduced.

The oligomerized biorenewable oil can be oligomerized via a variety of techniques, such as sulfurization as described in International Patent Application WO2016/138377; and such as blowing and stripping as described in U.S. 2016/0369203 and International Patent Application WO2016/149102.

The oligomerized biorenewable oil can include a modified biorenewable oligomerized oil, an unmodified biorenewable oligomerized oil, or a combination thereof. Modified oils can include oils modified utilizing maleic anhydride, acrylic acid, hydrogen, dicyclopentadiene, conjugation via reaction with iodine, interesterification, or a combination thereof.

The oligomerized biorenewable oil can include a sulfurized biorenewable oil. The oligomerized biorenewable oil can include a modified sulfurized biorenewable oil. The oligomerized biorenewable oil can include an unmodified sulfurized biorenewable oil.

In some aspects, the binder composition can further include a biorenewable oil, a modified biorenewable oil, an unmodified biorenewable oil, a non-oligomerized biorenewable oil, a petroleum-based oil, a modified petroleum-based oil, an unmodified petroleum-based oil, a non-oligomerized petroleum-based oil, or a combination thereof.

In some aspects, the binder composition can further include one or more additives such as an elastomer (e.g., rubber, such as ground tire rubber), a thermoplastic elastomer (e.g., a styrene-butadiene-styrene polymer, a styrene-butadiene-rubber polymer, a styrene-isoprene-styrene polymer, a styrene-ethylene-butadiene-styrene polymer, an ethylene-propylene-diene polymer, a isobutene-isoprene polymer, polybutadiene, polyisoprene), a thermoplastic polymer (e.g., ethylene vinyl acetate, ethylene methyl acrylate, ethylene butyl acrylate, polypropylene, polyethylene, polyvinyl chloride, polystyrene, a functionalized polyolefin), a thermosetting polymer (e.g., epoxy resin, polyurethane resin, acrylic resin, phenolic resin), a warm mix additive (e.g., an amine, an oil, a wax, a zeolite), a fiber (e.g., cellulose, alumina-magnesium silicate, glass fibers, asbestos, polyester, polypropylene), an emulsifier, an adhesion improver (e.g., an organic amine, an amide, an organo-silane), an anti-stripping additive, polyphosphoric acid, a filler (e.g., carbon black, hydrated lime, lime, fly ash), a rheology modifier (e.g., aromatic, naphthenic, and paraffinic distillates, base oils, re-refined engine oils and bottoms, waste oils), a cutback, an oil, a resin, a wax (e.g., Fischer-Tropsch wax, Montan wax, an amide wax), a surfactant, waste plastic, a pigment, or a combination thereof.

The binder composition can be free of a polymer modifier and/or polymer modification using a polymer modifier. In some aspects, the binder composition can include a polymer modifier and/or be polymer-modified using a polymer modifier, such as polystyrene, poly(divinylbenzene), poly(indene), styrene-butadiene-styrene polymer, polyolefin, a copolymer thereof, or a combination thereof. The polymer modifier can include or can be a styrene-butadiene-styrene polymer. The polymer modifier can be a crosslinked polymer modifier, or a polymer modifier that is free of crosslinking. The polymer modifier can be any suitable proportion of the binder composition, such as 0.01 wt % to 30 wt % of the binder composition, 0.5 wt % to 10 wt %, 1 wt % to 6 wt %, or 0.01 wt % or more, or less than, equal to, or greater than 0.05, 0.1, 0.2, 0.5, 0.6, 0.8, 1, 1.5, 2, 3, 4, 5, 6, 8, 10, 12, 14, 16, 18, 20, 22, 24, 26, or 28 wt %, or 30 wt % or less of the binder composition.

The binder composition can be free of an acid modifier and/or acid modification using an acid modifier. In some aspects, the binder composition can include an acid modifier and/or be acid-modified using an acid modifier, such as polyphosphoric acid. The acid modifier can be any suitable proportion of the binder composition, such as 0.3 wt % to 8 wt % of the binder composition, 1 wt % to 5 wt %, 1 wt % to 3 wt %, or 0.3 wt % or more, or less than, equal to, or greater than 0.4 wt %, 0.5, 0.6, 0.8, 1, 1.5, 2, 2.5, 3, 4, 5, 6, or 7 wt %, or 8 wt % or more.

In some aspects, the binder composition can include a bio-based filler. The bio-based filler can be any suitable bio-based filler (e.g., in addition to any bio-based filler present in the Asphaltene Additive), such as lignin (e.g., in addition to any lignin present in the Asphaltene Additive), a lignin-based biproduct, rosin, a rosin-based biproduct, a bio-based fiber, biomass, a pyrolysis product, biochar from pyrolysis of biomass, tall oil pitch, cellulosic matter from agricultural byproducts, or a combination thereof.

The binder composition can have any suitable performance grade as determined following AASHTO M 320-10, wherein a performance grade (PG) can be written as “PG A B” wherein A is the high temperature service temperature performance grade and wherein B is the low temperature service temperature performance grade. For example, PG 52-34 indicates a high temperature service temperature performance grade of 52° C. and a low temperature service temperature performance grade of −34° C. The binder composition can have any suitable performance grade, such as a performance grade of PG 52-34, PG 58-28, PG 58-34, PG 64-22, PG 64-28, PG 70-16, PG 70-22, or PG 76-22. The binder composition can have a performance grade of PG 52-34, PG 58-28, PG 64-22, or PG 70-16.

The binder composition can have a high temperature service temperature performance grade of 34 to 122° C. as determined following AASHTO M 320-10, or 46 to 82° C., or 52 to 70° C., or 30° C. or more, or less than, equal to, or greater than 34° C., 40, 46, 52, 58, 64, 70, 76, 82, 88, or 94° C., or less than or equal to 122° C.

The binder composition can have a low temperature service temperature performance grade of −46 to 22° C. as determined following AASHTO M 320-10, or −40 to −10° C., or −46° C. or more, or less than, equal to, or greater than −40° C., −37, −34, −28, −22, −16, −10, −4, 2, or 6° C., or less than or equal to 22° C.

The term UTI indicates the useful temperature interval, the difference between the high temperature performance grade and the low temperature performance grade, as determined using AASHTO M320. The binder composition can have a useful temperature interval of 86 to 120° C. as determined following AASHTO M320, or 92 to 104° C., or 86° C. or more, or less than, equal to, or greater than 88° C., 90, 92, 94, 96, 98, 100, 102, 104, 106, or 108° C., or less than or equal to 120° C.

The term O-DSR indicates the high temperature performance grade of the Unaged (“original”) asphalt binder as measured using a dynamic shear rheometer (DSR) following ASTM D7175 and AASHTO M320. The binder composition can have an O-DSR of 34 to 122° C. as determined following ASTM D7175 and AASHTO M320, or 52 to 70° C., or 30° C. or more, or less than, equal to, or greater than 34° C., 40, 46, 52, 58, 64, 70, 76, 82, 88, or 94° C., or less than or equal to 122° C.

The term R-DSR indicates the high temperature performance grade of the rolling thin film oven aged (RTFO, following ASTM D2872) asphalt binder as measured using a dynamic shear rheometer (DSR) following ASTM D7175 and AASHTO M320. The binder composition can have an R-DSR of 34 to 122° C. as determined following ASTM D7175 and AASHTO M320, or 52 to 70° C., or 30° C. or more, or less than, equal to, or greater than 35° C., 40, 45, 50, 52, 54, 56, 58, 60, 62, 64, 66, 68, 70, 75, 80, 85, 90, or 95° C., or less than or equal to 100° C.

The term S-BBR indicates the low temperature performance grade controlled by the creep stiffness parameter (“S”), as measured on an asphalt binder conditioned using both the rolling thin film oven or “RTFO” (ASTM D2872) and pressure aging vessel or “PAY” (ASTM D6521), using a bending beam rheometer following ASTM D6648 and AASHTO M320. The binder composition can have an S-BBR of −46 to 22° C. as determined following AASHTO M 320-10, or −40 to −10° C., or −46° C. or more, or less than, equal to, or greater than −40° C., −37, −34, −28, −22, −16, −10, −4, 2, or 6° C., or less than or equal to 22° C.

The binder composition can have an m-BBR of −46 to 22° C. as determined following AASHTO M 320-10, or −40 to −10° C., or −46° C. or more, or less than, equal to, or greater than −40° C., −37, −34, −28, −22, −16, −10, −4, 2, or 6° C., or less than or equal to 22° C. The term m-BBR indicates the low temperature performance grade controlled by the creep rate parameter (“m” value), as measured on an asphalt binder conditioned using both the rolling thin film oven (ASTM D2872) and pressure aging vessel (ASTM D6521), using a bending beam rheometer following ASTM D6648 and AASHTO M320.

The ASTM D5 standard describes the penetration testing of bitumen using a needle penetrometer. The penetration depth of the needle is recorded in units of dmm. Higher penetration values are generally indicative of lower viscosity or stiffness at the test temperature. The binder composition can have an unaged penetration of 15 to 220 dmm as determined following ASTM D5, or 30 to 100 dmm, or 15 dmm or more, or less than, equal to, or greater than 20 dmm, 25, 30, 35, 40, 45, 50, 55, 60, 65, 70, 75, 80, 85, 90, 95, 100, 110, 120, 130, 140, 150, 160, 170, 180, 190, 200, or 210 dmm, or less than or equal to 220 dmm. The binder composition can have an RTFO penetration of 15 to 220 dmm as determined following ASTM D5, or 30 to 100 dmm, or 15 dmm or more, or less than, equal to, or greater than 20 dmm, 25, 30, 35, 40, 45, 50, 55, 60, 65, 70, 75, 80, 85, 90, 95, 100, 110, 120, 130, 140, 150, 160, 170, 180, 190, 200, or 210 dmm, or less than or equal to 220 dmm.

The ASTM D3461 describes performing of the Drop Point or “Softening Point” test using a Mettler Drop Point tester. The drop point value has been closely correlated to the ASTM D36 Softening Point test, and is typically statistically equivalent. In the present invention, results, conclusions, and discussions based on the ASTM D3461 Drop Point are also representative of the ASTM D36 Softening Point. The binder composition can have an unaged softening point of 35 to 190° C. as determined following ASTM D3461, or 40 to 90° C., or 35° C. or more, or less than, equal to, or greater than 40° C., 42, 44, 46, 48, 50, 52, 54, 56, 58, 60, 62, 64, 66, 68, 70, 72, 74, 76, 78, 80, 82, 84, 86, 88, 90, 95, 100, 105, 110, 115, 120, 125, 130, 135, 140, 145, 150, 155, 160, 165, 170, 175, 180, or 185° C., or less than or equal to 190° C. The binder composition can have an RTFO softening point of 30 to 190° C. as determined following ASTM D3461 and ASTM D2872, or 40 to 90° C., or 45 to 65° C., or 30° C. or more, or less than, equal to, or greater than 35° C., 40, 42, 44, 46, 48, 50, 52, 54, 56, 58, 60, 62, 64, 66, 68, 70, 72, 74, 76, 78, 80, 82, 84, 86, 88, 90, 95, 100, 105, 110, 115, 120, 125, 130, 135, 140, 145, 150, 155, 160, 165, 170, 175, 180, or 185° C., or less than or equal to 190° C.

The binder composition can be a roofing shingle component, such as in a roofing shingle that includes the binder composition and a base material such as described herein. The binder composition can be a roofing shingle flux, which can be subjected to blowing to form a shingle coating. In some aspects of the binder composition that are suitable for using in a roofing shingle components, the binder composition can be a blown binder composition having an unaged penetration and/or an RTFO penetration of 3 to 40 dmm as determined following ASTM D5, or 5 to 30 dmm, or 10 to 20 dmm, or 3 dmm or more, or less than, equal to, or greater than 4 dmm, 6, 8, 10, 11, 12, 13, 14, 15, 16, 17, 18, 19, 20, 22, 24, 26, 28, 30, 32, 34, 36, or 38 dmm, or less than or equal to 40 dmm. The binder composition can be a blown binder composition having an unaged softening point and/or an RTFO softening point of 100 to 190° C. as determined following ASTM D3461 and ASTM D2872, or 110 to 130° C., or 115 to 125° C., or 100° C. or more, or less than, equal to, or greater than 102° C., 104, 106, 108, 110, 112, 114, 115, 116, 117, 118, 119, 120, 121, 122, 123, 124, 125, 126, 128, 130, 132, 134, 136, 140, 145, 150, 155, 160, 165, 170, 175, 180, or 185° C., or less than or equal to 190° C.

In various aspects, the binder composition of the present invention have a useful balance of properties and can provide very large performance grade useful temperature intervals and premium desirable performance grades without comprising other useful properties.

In some aspects, the roofing shingle component or roofing flux includes a binder composition that is a 50:50 blend of the biorenewable oil that is oligomerized and gilsonite, wherein the binder is substantially free of gilsonite. In some aspects, the roofing shingle component or roofing flux includes a binder composition that is a 48:48:4 blend of the biorenewable oil that is oligomerized, gilsonite, and one or more suitable additives.

### Asphalt Emulsion.

In various aspects, the present invention provides an asphalt emulsion. The asphalt emulsion includes the binder composition described herein and water that is emulsified with the binder composition. For example, the binder composition can include bitumen in addition to any bitumen included in the Asphaltene Additive, or the binder composition can be substantially free of bitumen other than any bitumen included in the Asphaltene Additive. The binder composition can include an oligomerized biorenewable oil that is at least 10 wt % of the binder composition. The binder composition can also include an Asphaltene Additive including at least 20 wt % to 100 wt % asphaltenes, wherein the Asphaltene Additive is at least 8 wt % of the binder composition.

The aqueous phase and the binder composition can be independently present as any suitable proportion of the asphalt emulsion.

### Asphalt Pavement.

In various aspects, the present invention provides an asphalt pavement. The asphalt pavement includes the binder composition described herein blended with the binder composition. For example, the binder composition can include bitumen in addition to any bitumen included in the Asphaltene Additive, or the binder composition can be substantially free of bitumen other than any bitumen included in the Asphaltene Additive. The binder composition can include an oligomerized biorenewable oil that is at least 10 wt % of the binder composition. The binder composition can also include an Asphaltene Additive including at least 20 wt % to 100 wt % asphaltenes, wherein the Asphaltene Additive is at least 8 wt % of the binder composition.

The aggregate and the binder composition can be independently present as any suitable proportion of the asphalt pavement. In some aspects, the binder composition can be a recycled binder composition, and the bitumen (if present in the binder composition) that is in addition to any bitumen included in the Asphaltene Additive can include or can be bitumen from RAP or RAS, bitumen obtained via a solvent de-asphalting process, such as propane-precipitated bitumen derived from the bottoms of a solvent de-asphalting process, or a combination thereof. In some aspects, the aggregate can include or can be virgin aggregate. In some aspects, the asphalt can be a recycled pavement, and the bitumen includes recycled or aged bitumen, the aggregate includes aggregate derived from a recycled asphalt composition such as recycled or aged asphalt concrete or shingles, or a combination thereof.

The aggregate can be any suitable aggregate used for asphalt pavement, such as sand, gravel, crushed stone, slag, recycled concrete, aggregate obtained from a recycled asphalt composition, aggregate obtained from RAP or RAS, geosynthetic additives, or a combination thereof.

In some aspects, the pavement includes a binder composition that is a 50:50 blend of the biorenewable oil that is oligomerized and gilsonite, wherein the binder is substantially free of additives. In some aspects, the pavement includes a binder composition that is a 48:48:4 blend of the biorenewable oil that is oligomerized, gilsonite, and one or more suitable additives.

### Roofing Shingle.

In various aspects, the present invention provides a roofing shingle. The roofing shingle includes the binder composition described herein and a base material. For example, the binder composition can include bitumen in addition to any bitumen included in the Asphaltene Additive, or the binder composition can be substantially free of bitumen other than any bitumen included in the Asphaltene Additive. The binder composition can include an oligomerized biorenewable oil that is at least 10 wt % of the binder composition. The binder composition can also include an Asphaltene Additive including at least 20 wt % to 100 wt % asphaltenes, wherein the Asphaltene Additive is at least 8 wt % of the binder composition. The binder composition can be a shingle coating.

The base material and the binder composition can be independently present as any suitable proportion of the roofing shingle. The base material can be any suitable base material for shingles. The base material can include an organic material, fiberglass, or a combination thereof. The organic material can include paper, cellulose, wood fibers, or a combination thereof.

In some aspects, the binder composition of the roofing shingle can be a blown binder composition having an unaged penetration and/or an RTFO penetration of 3 to 40 dmm as determined following ASTM D5, or 5 to 30 dmm, or 10 to 20 dmm, or 3 dmm or more, or less than, equal to, or greater than 4 dmm, 6, 8, 10, 11, 12, 13, 14, 15, 16, 17, 18, 19, 20, 22, 24, 26, 28, 30, 32, 34, 36, or 38 dmm, or less than or equal to 40 dmm. The binder composition can be a blown binder composition having an unaged softening point and/or an RTFO softening point of 100 to 190° C. as determined following ASTM D3461 and ASTM D2872, or 110 to 130° C., or 115 to 125° C., or 100° C. or more, or less than, equal to, or greater than 102° C., 104, 106, 108, 110, 112, 114, 115, 116, 117, 118, 119, 120, 121, 122, 123, 124, 125, 126, 128, 130, 132, 134, 136, 140, 145, 150, 155, 160, 165, 170, 175, 180, 185° C., or less than or equal to 190° C.

### Method of Making a Binder Composition.

In various aspects, the present invention provides a method of making a binder composition. The method includes forming the binder composition described herein. For example, the method can including forming the binder composition, wherein the binder composition includes an oligomerized biorenewable oil that is at least 10 wt % of the binder composition; and an Asphaltene Additive including at least 20 wt % to 100 wt % asphaltenes, wherein the Asphaltene Additive is at least 8 wt % of the binder composition. The binder composition can include bitumen in addition to any bitumen included in the Asphaltene Additive, or the binder composition can be substantially free of bitumen other than any bitumen included in the Asphaltene Additive.

The binder composition can include bitumen in addition to any bitumen included in the Asphaltene Additive. The components of such a binder composition can be combined in any suitable order. For example, the Asphaltene Additive including at least 20 wt % to 100 wt % asphaltenes (e.g., gilsonite) can be added to a blend of bitumen and the oligomerized biorenewable oil. In other aspects, the Asphaltene Additive including at least 20 wt % to 100 wt % asphaltenes and the oligomerized biorenewable oil can be pre-blended into a mixture. The Asphaltene Additive including at least 20 wt % to 100 wt % asphaltenes can be in any suitable form in the finished mixture, such as suspended or dissolved. The pre-blended mixture can then be combined with the bitumen to form the binder composition. In some aspects, using a pre-blend including the Asphaltene Additive including at least 20 wt % to 100 wt % asphaltenes and the oligomerized biorenewable oil can provide improved homogenization of the binder composition and can allow formation of the binder composition with lower temperatures, less shear, or a combination thereof, as compared to formation of the binder composition with addition of the Asphaltene Additive including at least 20 wt % to 100 wt % asphaltenes to a blend of the bitumen and the oligomerized biorenewable oil.

In various aspects, the present invention provides a pre-blend for use in forming a binder composition that includes bitumen in addition to any bitumen included in the Asphaltene Additive. The pre-blend can include a mixture of the oligomerized biorenewable oil and the Asphaltene Additive including at least 20 wt % to 100 wt % asphaltenes. The pre-blend can be substantially free of bitumen other than any bitumen that is included in the Asphaltene Additive. The pre-blend can include any suitable proportions of the biorenewable oil that is oligomerized, and of the Asphaltene Additive, suitable for forming the binder composition described herein. For example, the biorenewable oil that is oligomerized can be 7 wt % to 55 wt % of the pre-blend, or 9 wt % to 40 wt %, or 7 wt % or more, or less than, equal to, or greater than 8 wt %, 10, 15, 20, 25, 30, 35, 40, 45, 50 wt %, or 55 wt % or less. The Asphaltene Additive including at least 20 wt % to 100 wt % asphaltenes can be 9 wt % to 72 wt % of the pre-blend, or 20 wt % to 40 wt %, or 9 wt % or more, or less than, equal to, or greater than 10 wt %, 15, 20, 25, 30, 35, 40, 45, 50, 55, 60, 65, 70 wt %, or 72 wt % or less. The pre-blend can optionally include or be free of any one or more of the other components described as suitable for inclusion in the binder composition, such as additives such as an elastomer (e.g., rubber, such as ground tire rubber), a thermoplastic elastomer (e.g., a styrene-butadiene-styrene polymer, a styrene-butadiene-rubber polymer, a styrene-isoprene-styrene polymer, a styrene-ethylene-butadiene-styrene polymer, an ethylene-propylene-diene polymer, a isobutene-isoprene polymer, polybutadiene, polyisoprene), a thermoplastic polymer (e.g., ethylene vinyl acetate, ethylene methyl acrylate, ethylene butyl acrylate, polypropylene, polyethylene, polyvinyl chloride, polystyrene, a functionalized polyolefin), a thermosetting polymer (e.g., epoxy resin, polyurethane resin, acrylic resin, phenolic resin), a warm mix additive (e.g., an amine, an oil, a wax, a zeolite), a fiber (e.g., cellulose, alumina-magnesium silicate, glass fibers, asbestos, polyester, polypropylene), an emulsifier, an adhesion improver (e.g., an organic amine, an amide, an organo-silane), an anti-stripping additive, polyphosphoric acid, a filler (e.g., carbon black, hydrated lime, lime, fly ash), a rheology modifier (e.g., aromatic, naphthenic, and paraffinic distillates, base oils, re-refined engine oils and bottoms, waste oils), a cutback, an oil, a resin, a wax (e.g., Fischer-Tropsch wax, Montan wax, an amide wax), a surfactant, waste plastic, a pigment, or a combination thereof; a polymer modifier and/or polymer modification; an acid modifier and/or acid modification; a bio-based filler; or a combination thereof. The pre-blend can be the same as binder compositions described herein that are substantially free of bitumen other than any bitumen included in the Asphaltene Additive, and can have the same or different properties as the binder composition described herein.

### Method of Making an Asphalt Emulsion.

In various aspects, the present invention provides a method of making an asphalt emulsion. The method including emulsifying the binder composition described herein and an aqueous phase (e.g., water). For example, the binder composition can include bitumen in addition to any bitumen included in the Asphaltene Additive, or the binder composition can be substantially free of bitumen other than any bitumen included in the Asphaltene Additive. The binder composition can include an oligomerized biorenewable oil that is at least 10 wt % of the binder composition. The binder composition can also include an Asphaltene Additive including at least 20 wt % to 100 wt % asphaltenes, wherein the Asphaltene Additive is at least 8 wt % of the binder composition.

The aqueous phase and the binder composition can be independently present as any suitable proportion of the asphalt emulsion. The emulsification of the aqueous phase and the binder composition can be conducted via any suitable emulsifying technique.

### Method of Making an Asphalt Pavement.

In various aspects, the present invention provides a method of making an asphalt pavement. The method includes combining the binder composition described herein with an aggregate. For example, the binder composition can include bitumen in addition to any bitumen included in the Asphaltene Additive, or the binder composition can be substantially free of bitumen other than any bitumen included in the Asphaltene Additive. The binder composition can include an oligomerized biorenewable oil that is at least 10 wt % of the binder composition. The binder composition can also include an Asphaltene Additive including at least 20 wt % to 100 wt % asphaltenes, wherein the Asphaltene Additive is at least 8 wt % of the binder composition.

The aggregate and the binder composition can be independently present as any suitable proportion of the asphalt pavement. In some aspects, the binder composition can include a recycled binder component, and bitumen in addition to any bitumen included in the Asphaltene Additive can include or can be bitumen from RAP or RAS, bitumen obtained via a solvent de-asphalting process, such as propane-precipitated bitumen derived from the bottoms of a solvent de-asphalting process, or a combination thereof. In some aspects, the aggregate can include or can be virgin aggregate. In some aspects, the asphalt pavement can be a recycled pavement, and the aggregate can include aggregate derived from a recycled asphalt composition (e.g., RAP or RAS), the bitumen can include bitumen from a recycled asphalt composition such as recycled or aged asphalt concrete or shingles, or a combination thereof.

The aggregate can be any suitable aggregate used for asphalt pavement, such as sand, gravel, crushed stone, slag, recycled concrete, aggregate obtained from RAP or RAS, geosynthetic additives, or a combination thereof.

### Method of Making a Roofing Shingle.

In various aspects, the present invention provides a method of making a roofing shingle. The method includes combining the binder composition described herein with a based material. For example, the binder composition can include bitumen in addition to any bitumen included in the Asphaltene Additive, or the binder composition can be substantially free of bitumen other than any bitumen included in the Asphaltene Additive. The binder composition can include an oligomerized biorenewable oil that is at least 10 wt % of the binder composition. The binder composition can also include an Asphaltene Additive including at least 20 wt % to 100 wt % asphaltenes, wherein the Asphaltene Additive is at least 8 wt % of the binder composition.

The base material and the binder composition can be independently present as any suitable proportion of the roofing shingle. The base material can be any suitable base material for shingles. The base material can be any suitable base material for shingles. The base material can include an organic material, fiberglass, or a combination thereof. The organic material can include paper, cellulose, wood fibers, or a combination thereof.

The binder composition can be a shingle coating, and the method of making a roofing shingle can include applying the coating to the base material. For such applications the binder composition can be air blown to a high softening point. The binder composition can air blown alone or in a blend with bitumen in addition to any bitumen included in the Asphaltene Additive, and therefore can be capable of tolerating the harsh air blower conditions at temperatures that may range to about 200° C. to 250° C. The binder composition can include a oligomerized biorenewable oil wherein the oligomerization is achieved via sulfurization. The binder composition may be added in part or in its entirety prior to the start of the blowing process, or at some point prior to the end of the blowing process, such as when a catalyst is added. The binder composition may be preblended with the catalysts.

### EXAMPLES

Various aspects of the present invention can be better understood by reference to the following Examples which are offered by way of illustration. The present invention is not limited to the Examples given herein.

The term ΔTc indicates the difference of the BBR S grade and the BBR m grade (S-BBR minus m-BBR), at 20 hrs of PAV aging. A trend towards lower or more negative ΔTc values have been taken to be broadly indicative of a decrease in bitumen compatibility, colloidal stability, and durability in the literature. An increasing trend toward larger or more positive values is desirable.

Using AASHTO M320 the performance grade of bitumen is determined as the range defined the lower of the two DSR grades and the higher of the two BBR grades.

A PG64-22 has a high temperature grade of 64° C. and a low temperature grade of −22° C., and is one of the most common paving grade bitumen grades (PG64-22). Other grades commonly used in paving are PG58-28 and PG52-34. These grades span temperatures of 64° C. down to −34° C. and cover the majority of pavements globally, and are equivalent to grades mostly used in other regions in the world. In some very warm regions grades such as PG64-16 and PG70-16, and very rarely PG70-10 are used. In colder regions a PGXX-34 or a PG46-40 may be used, with the XX″ indicative of the potential for the high temperature grade to vary between 46 and 52° C. from batch to batch.

The numeric difference between the grades is referred to as the “Useful Temperature Interval” or “UTI”. Typical paving grade bitumen have a UTI greater than 86° C. Some premium grades have higher UTI values, such as PG76-22, PG70-22, PG64-28, PG64-34, and PG58-34 and PG52-40. Such are grades are less common but highly desirable due to their coverage of a higher temperature span, therefore offering higher flexibility and reliability in their application. These grades are also offered at a premium due to the cost and difficulty associated with their manufacturing, which typically involves about 1 to 3% by weight of a polymer such as styrene butadiene styrene, or 0.5 to 1.0% of PPA. High temperature grades higher than 76° C. are unusual for paving grade bitumen, but are not problematic if they are paired with low temperature grades that are sufficiently low (e.g. −16 or −22° C.).

Inversely, bitumen with grades such as PG64-16 and PG70-10 have low UTIs of 80° C. and are often considered less desirable. Such binders are often also afflicted with negative ΔTc values.

Although the Performance Grading (PG) system of bitumen grading is mostly used in North America and a few other countries, all bitumen around the world can be graded in such a manner, and therefore their use in this patent is not meant to be in exclusion of the application of these examples to any particular region or geography. Many countries use some combination of penetration, softening point, and viscosity as the as basis of grading (i.e., enetration grading, or viscosity grading). For example a Pen 50/70 grade (Penetration at 25° C. is between 50 and 70 dmm) would typically grade as a PG64-22 in the PG system, and a Pen 70/100 would often grade as a PG58-28. Other grades of potential use are Pen 40/60 which is typically close to a PG64-16 or a PG70-16, and Pen 160/220 which is close to a PGXX-34.

In the production of bituminous coating for roofing shingles through blowing of roofing flux, a high softening point is targeted and controlled through the blowing process. The penetration of the resulting coating needs to be higher than a specific minimum penetration value to insure flexibility and durability of the shingle coating.

Based on gilsonite literature, often blending temperatures of 185 to 220° C. and blending times of 4 to 6 hrs are required to fully incorporate the gilsonite into bitumen. Such temperatures are higher than typical bitumen processing temperatures and can be detrimental to bitumen quality due to volatilization of certain lower boiling point fractions which provide the bitumen flexibility (i.e. lower molecular weight cyclic molecules as defined in the “aromatic” fraction).

In the following examples using gilsonite, blending times and temperatures as low as 1 hour at 155° C. and as high as 2 hours at 180° C. were used. The gilsonite used in the examples was a fine black powder produced by American Gilsonite. 100% of the material passed through a standard ASTM #16 mesh, with about 11% wt. retained on a #30 mesh, and about 65% wt. retained on a #100 mesh.

### Example 1. Composition Including Oligomerized Biorenewable Oil and Gilsonite

A sulfurized refined soybean oil reacted with 7.0% by weight of elemental sulfur at 160° C. for 19 hrs under a nitrogen purge. The sulfurized refined soybean oil had 70.8 wt % oligomers and is referred to herein as “MO #1”. MO #1 was blended with gilsonite at 155° C. using a benchtop low shear drill mixer at 200 RPM for 1 hours to form the binder composition. No bitumen was used in the binder composition.

TABLE 1
Example 1 Binder Composition.

| | | | | | | Penetration | | | |
|---|---|---|---|---|---|---|---|---|---|
| | | | | | | (dmm) | | Softening Point (° C.) | |
| | Binder Proportions | | | O-DSR | R-DSR | ASTM D5 | | ASTM D3461 | |
| Binder Name | Bitumen | MO#1 | Gilsonite | ° C. | ° C. | Unaged | RTFO | Unaged | RTFO |
| Binder Blend #1 | 0.0% | 50% | 50% | 112.9 | 118.0 | 44.3 | 33.7 | 102.0 | 117.0 |

The gilsonite was fully dissolved and incorporated into the resulting binder composition, which is visually similar to bitumen. Furthermore, the composition can be readily blended with other bitumen to create new grade, as well as providing an efficient and thermally stable method for incorporating gilsonite into bitumen with less rigorous blending energy.

### Example 2. Composition Including Oligomerized Biorenewable Oil and Gilsonite

A diluted sulfurized refined soybean oil was formed including a blend of “MO #1” and refined soybean oil. This resulted in an oil with about 45% oligomer content, hereby referred to as “MO #2”. “MO #2” and gilsonite were heated to 180° C. and blended using a benchtop low shear drill mixer at 500 RPM for 2 hours to form the binder composition. No bitumen was used in the binder composition.

TABLE 2
Example 2 Binder Composition.

| | | | | | | Penetration | | | |
|---|---|---|---|---|---|---|---|---|---|
| | | | | | | (dmm) | | Softening Point (° C.) | |
| | Binder Proportions | | | O-DSR | R-DSR | ASTM D5 | | ASTM D3461 | |
| Binder Name | Bitumen | MO#2 | Gilsonite | ° C. | ° C. | Unaged | RTFO | Unaged | RTFO |
| Binder Blend #2 | 0.0% | 50% | 50% | 85.05 | 94.74 | 70.7 | 50.3 | 69.2 | 89.2 |

The gilsonite was fully dissolved and incorporated into the resulting binder composition, which is visually similar to bitumen, and exhibited some of the rheological properties of bitumen. Furthermore, the composition can be readily blended with other bitumen to create new grade, as well as providing an efficient and thermally stable method for incorporating gilsonite into bitumen with less rigorous blending energy.

### Example 3. Binder Composition Including Oligomerized Biorenewable Oil, Gilsonite, and Bitumen

A binder composition was formed including gilsonite, a neat asphalt binder graded as PG64-22 (PG 64.88-24.7), and the sulfurized refined soybean oil previously identified as “MO #1”. The components were blended at 155° C. for 1 hour using a benchtop low shear drill mixer at 200 RPM. Performance grade tests were performed in accordance to AASHTO M320. Table 1 shows the blends and the resulting performance grades.

TABLE 3
Base Bitumen 1 and Samples 3-8.

| | | | | | | | Mass | | | | |
|---|---|---|---|---|---|---|---|---|---|---|---|
| Binder | Binder Proportions | | | UTI | O-DSR | R-DSR | Change | S-BBR | m-BBR | ΔTc | Standard |
| Name | BB#1 | MO#1 | Gilsonite | ° C. | ° C. | ° C. | % wt. | ° C. | ° C. | ° C. | PG |
| Base | 100.0% | 0% | 0% | 92.3 | 67.61 | 67.50 | −0.580 | −24.8 | −25.0 | +0.2 | PG64-22 |
| Bitumen | | | | | | | | | | | |
| (BB#1) | | | | | | | | | | | |
| Binder | 90.0% | 0% | 10.0% | 98.05 | 79.25 | 80.05 | −0.506 | −20.5 | −18.8 | −1.7 | PG76-16 |
| Blend #3 | | | | | | | | | | | |
| Binder | 80.0% | 0% | 20.0% | 105.03 | 92.03 | 92.26 | −0.508 | −16.0 | −13.0 | −3.0 | PG88-10 |
| Blend #4 | | | | | | | | | | | |
| Binder | 75.0% | 25.0% | 0% | 84.15 | 40.05 | 39.46 | −0.467 | −44.1 | −46.0 | +1.9 | PG34-40 |
| Blend #5 | | | | | | | | | | | |
| Binder | 54.0% | 25.0% | 21.0% | 106.01 | 69.11 | 72.17 | −0.432 | −37.7 | −36.9 | −0.8 | PG64-34 |
| Blend #6 | | | | | | | | | | | |
| Binder | 59.0% | 25.0% | 16.0% | 100.8 | 61.90 | 63.44 | −0.418 | −38.9 | −39.8 | +0.9 | PG58-34 |
| Blend #7 | | | | | | | | | | | |
| Binder | 64.0% | 25.0% | 11.0% | 95.03 | 54.43 | 55.77 | −0.321 | −40.6 | −41.6 | +1.0 | PG52-40 |
| Blend #8 | | | | | | | | | | | |

BB #1 is one of the most common paving grade bitumen grades (PG64-22). It is hereby used as both the blend base and as a control and basis of comparison to the other blends. The results show that the increase in gilsonite content (blends BB #1, #3 and #4) resulted in a significant increase in the high temperature grade (O-DSR and R-DSR) and a deterioration of the low temperature grade, in other words an overall stiffening of the binder. Furthermore, the ΔTc values become progressively more negative with the increase in gilsonite content. In the case of Blend #5, a performance grade of PG88-10 is achieved, which is not a typical paving grade binder due to the excessive stiffness.

On the other hand, incorporation of MO #1 balanced this trend across the board in all mentioned properties. In the case of Binder Blend #5, the binder composition meets (and improves on) the base and control bitumen (BB #1), while significantly improving on the low temperature. The resulting grade of PG64-34 is a highly premium grade that would meet the paving grade climatic requirements of most of North America. Furthermore, Blends #6 and #7 are also highly desirable larger portions of the typical performance temperature range of interest (64 to −34° C.), while incorporating high amounts of both gilsonite and the oligomerized biorenewable oil.

### Example 4. Binder Composition Including Oligomerized Biorenewable Oil, Gilsonite, and Propane-Precipitated Bitumen (PPB)

A binder composition was formed including “MO #1”, gilsonite, and a propane-precipitated bitumen derived from the bottoms of a solvent de-asphalting process. The components were blended into the bitumen at 155° C. for 1 hour using a benchtop low shear drill mixer at 200 RPM. Performance grade tests were performed in accordance to AASHTO M320. Tables 4 and 5 show the blends and the resulting performance grades.

For Binder Blend #11 the gilsonite was introduced through use of the binder composition previously identified as “Binder Blend #1”, which was gilsonite dissolved in the MO #1 oligomerized biorenewable oil. The resulting incorporation process significantly simplified the process, eliminating the necessity of incorporating the powdered gilsonite, and instead reducing the complexity of the multi-additive blending process to a simple blend of two binders, which is a very typical blending process for paving grade bitumen in the industry. The results show statistically similar rheological properties (penetration and softening point) between Blend #10 and Blend #11, confirming the equivalence of the resulting products.

TABLE 4
Base Bitumen 2.

| | | | | | | | Mass | | m- | | |
|---|---|---|---|---|---|---|---|---|---|---|---|
| Binder | Binder Proportions | | | UTI | O-DSR | R-DSR | Change | S-BBR | BBR | ATc | Standard |
| Name | BB#2 | MO#1 | Gilsonite | ° C. | ° C. | ° C. | % wt. | ° C. | ° C. | ° C. | PG |
| Base | 100.0% | 0% | 0% | 93.1 | 84.3 | 83.7 | 0.163 | −12.9 | −9.4 | −3.5 | PG82-6 |
| Bitumen | | | | | | | | | | | |
| (BB#2) | | | | | | | | | | | |

TABLE 5
Samples 9-10.

| | | | | | | | S- | m- | Penetration | | Softening | |
|---|---|---|---|---|---|---|---|---|---|---|---|---|
| Binder | Binder Proportions | | | | O-DSR | R-DSR | BBR | BBR | (dmm) | | Point (° C.) | |
| Name | BB#2 | MO#1 | Gilsonite | Blend#1 | ° C. | ° C. | ° C. | ° C. | Unaged | RTFO | Unaged | RTFO |
| Binder | 16.0% | 40.0% | 44.0% | 0% | 103.90 | 102.33 | N/A | N/A | 34.7 | 24.7 | 85.5 | 93.16 |
| Blend | | | | | | | | | | | | |
| #9 | | | | | | | | | | | | |
| Binder | 40.0% | 30.0% | 30.0% | 0% | 86.84 | 87.36 | −24.6 | −20.8 | 40.7 | 30.7 | 67.57 | 75.88 |
| Blend | | | | | | | | | | | | |
| #10 | | | | | | | | | | | | |
| Binder | 40.0% | 0% | 0% | 60% | N/A | N/A | N/A | N/A | 40.0 | N/A | 70.71 | N/A |
| Blend | | | | | | | | | | | | |
| #11 | | | | | | | | | | | | |

### Example 5. Binder Composition Including Oligomerized Biorenewable Oil, Gilsonite, and Polyphosphoric Acid-Modified Bitumen

Binder compositions were formed that included “MO #1”, gilsonite, asphalt binder BB #1, and polyphosphoric acid (PPA).

For Binder Blend #12, the bitumen was first blended with the PPA, followed by the addition of the oligomerized biorenewable oil and gilsonite. The components were blended at 180° C. for 2 hours using a benchtop low shear drill mixer at 500 RPM. However, the resulting blend was a grainy binder which was surprisingly non-tacky. It is hypothesized that the interaction between the PPA and gilsonite may have resulted in rapid gelling of the gilsonite, preventing effective compatibilization with the oligomerized biorenewable oil. It is noted that the material exhibited interesting properties and may be of potential industrial application, however, it was deemed unsuitable for asphalt paving application.

To address this issue, for Binder Blend #13 the gilsonite was introduced through use of the binder composition previously identified as “Binder Blend #1”, which was gilsonite dissolved in the MO #1 oligomerized biorenewable oil. Due to the ease of incorporation of such a blend compared to direct use of gilsonite, the blend temperatures and conditions were reduced compared to the Blend #12, by blending at 155° C. for 1 hour using a benchtop low shear drill mixer at 200 RPM. The resulting mix was smooth, seemed fully homogenized, and showed a significant increase in softening point, highlighting the utility of the aforementioned aspect of this invention in which full digestion of the gilsonite in the oligomerized biorenewable oil provided the means for a compatible and thermally stable incorporation of high amounts of gilsonite into the binder composition. The results demonstrate the synergistic impact of using PPA in conjunction with Asphaltene Additives such as gilsonite for increasing the modulus of the binder.

TABLE 6
Example 5 Binder Composition.

| | | | | | | Softening |
|---|---|---|---|---|---|---|
| | Binder Proportions | | | | | (°C) |
| Binder Name | BB#1 | PPA | MO#1 | Gilsonite | Binder#1 | Point |
| Binder Blend | 13.0% | 2.0% | 45% | 40% | 0% | 51.4 |
| #12 | | | | | | |
| Binder Blend | 13.0% | 2.0% | 5% | 0% | 80% | 178.2 |
| #13 | | | | | | |

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects.

The following exemplary aspects are provided, the numbering of which is not to be construed as designating levels of importance:

Aspect 1 provides a binder composition comprising:

an oligomerized biorenewable oil that is at least 10 wt % of the binder composition; and

an Asphaltene Additive comprising at least 20 wt % to 100 wt % asphaltenes, wherein the Asphaltene Additive is at least 8 wt % of the binder composition.

Aspect 2 provides the binder composition of Aspect 1, wherein the binder composition comprises bitumen in addition to any bitumen comprised in the Asphaltene Additive, wherein low molecular weight and low polarity naphthenic or aromatic molecules and the saturates fraction are about 0 wt % to about 40 wt % of the Asphaltene Additive, asphaltenes are about 1 wt % to about 70 wt % of the binder composition, or a combination thereof.

Aspect 3 provides the binder composition of any one of Aspects 1-2, wherein asphaltenes are 30 wt % to 90 wt % of the Asphaltene Additive, or wherein asphaltenes are 50 wt % to 80 wt % of the Asphaltene Additive.

Aspect 4 provides the binder composition of any one of Aspects 1-3, wherein the Asphaltene Additive is at least 10 wt % of the binder composition.

Aspect 5 provides the binder composition of any one of Aspects 1-4, wherein the Asphaltene Additive is 8 wt % to 60 wt % of the binder composition.

Aspect 6 provides the binder composition of any one of Aspects 1-5, wherein the Asphaltene Additive is 10 wt % to 45 wt % of the binder composition.

Aspect 7 provides the binder composition of any one of Aspects 1-6, wherein the Asphaltene Additive is gilsonite, uintahite, residuum oil supercritical extract, or a combination thereof.

Aspect 8 provides the binder composition of any one of Aspects 1-7, wherein the Asphaltene Additive is gilsonite.

Aspect 9 provides the binder composition of any one of Aspects 1-8, wherein the binder composition comprises bitumen in addition to any bitumen comprised in the Asphaltene Additive, wherein the additional bitumen comprises virgin bitumen.

Aspect 10 provides the binder composition of any one of Aspects 1-9, wherein the binder composition comprises bitumen in addition to any bitumen comprised in the Asphaltene Additive, wherein the additional bitumen comprises recycled bitumen.

Aspect 11 provides the binder composition of any one of Aspects 1-10, wherein the binder composition comprises bitumen in addition to any bitumen comprised in the Asphaltene Additive, wherein the additional bitumen is 10 wt % to 90 wt % of the binder composition.

Aspect 12 provides the binder composition of any one of Aspects 1-11, wherein the binder composition comprises bitumen in addition to any bitumen comprised in the Asphaltene Additive, wherein the additional bitumen is 15 wt % to 90 wt % of the binder composition.

Aspect 13 provides the binder composition of any one of Aspects 1-12, wherein the oligomerized biorenewable oil has not been blended with any non-oligomerized oil after oligomerization.

Aspect 14 provides the binder composition of any one of Aspects 1-13, wherein oligomer molecules are 5 wt % to 100 wt % of the oligomerized biorenewable oil.

Aspect 15 provides the binder composition of any one of Aspects 1-14, wherein oligomer molecules are 65 wt % to 75 wt % of the oligomerized biorenewable oil.

Aspect 16 provides the binder composition of any one of Aspects 1-15, wherein the oligomerized biorenewable oil has been blended with a non-oligomerized biorenewable oil after oligomerization.

Aspect 17 provides the binder composition of any one of Aspects 1-16, wherein the oligomerized biorenewable oil comprises a biorenewable oil that has been oligomerized via sulfurization, bodying, blowing, or a combination thereof.

Aspect 18 provides the binder composition of any one of Aspects 1-17, wherein the oligomerized biorenewable oil comprises a sulfurized biorenewable oil.

Aspect 19 provides the binder composition of any one of Aspects 1-18, wherein the oligomerized biorenewable oil comprises a modified sulfurized biorenewable oil.

Aspect 20 provides the binder composition of any one of Aspects 1-19, wherein the oligomerized biorenewable oil comprises an unmodified sulfurized biorenewable oil.

Aspect 21 provides the binder composition of any one of Aspects 1-20, wherein the oligomerized biorenewable oil comprises a modified oligomerized biorenewable oil.

Aspect 22 provides the binder composition of any one of Aspects 1-21, wherein the oligomerized biorenewable oil is 10 wt % to 80 wt % of the binder composition.

Aspect 23 provides the binder composition of any one of Aspects 1-22, wherein the oligomerized biorenewable oil is 20 wt % to 45 wt % of the binder composition.

Aspect 24 provides the binder composition of any one of Aspects 1-23, further comprising a biorenewable oil, a modified biorenewable oil, an unmodified biorenewable oil, a non-oligomerized biorenewable oil, a petroleum-based oil, a modified petroleum-based oil, an unmodified petroleum-based oil, a non-oligomerized petroleum-based oil, or a combination thereof.

Aspect 25 provides the binder composition of any one of Aspects 1-24, further comprising an elastomer, a thermoplastic elastomer, a thermoplastic polymer, a thermosetting polymer, a warm mix additive, a fiber, an emulsifier, an adhesion improver, an anti-stripping additive, polyphosphoric acid, a filler, a rheology modifier, a cutback, an oil, a resin, a wax, a surfactant, waste plastic, a pigment, or a combination thereof.

Aspect 26 provides the binder composition of any one of Aspects 1-25, wherein the binder composition is free of aggregate.

Aspect 27 provides the binder composition of any one of Aspects 1-26, wherein the binder composition comprises a polymer modifier, wherein the binder composition is modified using the polymer modifier, or a combination thereof.

Aspect 28 provides the binder composition of Aspect 27, wherein the polymer modifier is 0.01 wt % to 30 wt % of the binder composition.

Aspect 29 provides the binder composition of any one of Aspects 27-28, wherein the polymer modifier is 0.5 wt % to 10 wt % of the binder composition.

Aspect 30 provides the binder composition of any one of Aspects 27-29, wherein the polymer modifier is a polystyrene, poly(divinylbenzene), poly(indene), a styrene-butadiene-styrene polymer, a polyolefin, a copolymer thereof, or a combination thereof.

Aspect 31 provides the binder composition of any one of Aspects 27-30, wherein the polymer modifier is a styrene-butadiene-styrene polymer.

Aspect 32 provides the binder composition of any one of Aspects 1-31, wherein the binder composition comprises an acid modifier, wherein the binder composition is modified using the acid modifier, or a combination thereof.

Aspect 33 provides the binder composition of any one of Aspects 32, wherein the acid modifier is 0.3 wt % to 8 wt % of the binder composition.

Aspect 34 provides the binder composition of any one of Aspects 32-33, wherein the acid modifier is 1 wt % to 3 wt % of the binder composition.

Aspect 35 provides the binder composition of any one of Aspects 32-34, wherein the acid modifier is polyphosphoric acid.

Aspect 36 provides the binder composition of any one of Aspects 1-35, further comprising a bio-based filler.

Aspect 37 provides the binder composition of Aspect 36, wherein the bio-based filler comprises lignin, a lignin-based biproduct, rosin, a rosin-based biproduct, a bio-based fiber, biomass, a pyrolysis product, biochar from pyrolysis of biomass, tall oil pitch, cellulosic matter from agricultural byproducts, or a combination thereof.

Aspect 38 provides the binder composition of any one of Aspects 1-37, wherein the binder composition has a high temperature service temperature performance grade of 34 to 122° C. as determined following AASHTO M 320-10.

Aspect 39 provides the binder composition of any one of Aspects 1-38, wherein the binder composition has a high temperature service temperature performance grade of 46 to 82° C. as determined following AASHTO M 320-10.

Aspect 40 provides the binder composition of any one of Aspects 1-39, wherein the binder composition has a high temperature service temperature performance grade of 52 to 70° C. as determined following AASHTO M 320-10.

Aspect 41 provides the binder composition of any one of Aspects 1-40, wherein the binder composition has a low temperature service temperature performance grade of −46 to 22° C. as determined following AASHTO M 320-10.

Aspect 42 provides the binder composition of any one of Aspects 1-41, wherein the binder composition has a low temperature service temperature performance grade of −40 to −10° C. as determined following AASHTO M 320-10.

Aspect 43 provides the binder composition of any one of Aspects 1-42, wherein the binder composition has a useful temperature interval of 86 to 110° C. as determined following AASHTO M320.

Aspect 44 provides the binder composition of any one of Aspects 1-43, wherein the binder composition has a useful temperature interval of 92 to 104° C. as determined following AASHTO M320.

Aspect 45 provides the binder composition of any one of Aspects 1-44, wherein the binder composition has an O-DSR of 34 to 122° C. as determined following ASTM D7175 and AASHTO M320.

Aspect 46 provides the binder composition of any one of Aspects 1-45, wherein the binder composition has an O-DSR of 52 to 70° C. as determined following ASTM D7175 and AASHTO M320.

Aspect 47 provides the binder composition of any one of Aspects 1-46, wherein the binder composition has an R-DSR of 34 to 122° C. as determined following ASTM D7175 and AASHTO M320.

Aspect 48 provides the binder composition of any one of Aspects 1-47, wherein the binder composition has an R-DSR of 52 to 70° C. as determined following ASTM D7175 and AASHTO M320.

Aspect 49 provides the binder composition of any one of Aspects 1-48, wherein the binder composition has an S-BBR of −46 to 22° C. as determined following ASTM D6648 and AASHTO M320.

Aspect 50 provides the binder composition of any one of Aspects 1-49, wherein the binder composition has an S-BBR of −40 to −10° C. as determined following ASTM D6648 and AASHTO M320.

Aspect 51 provides the binder composition of any one of Aspects 1-50, wherein the binder composition has an m-BBR of −46 to 22° C. as determined following ASTM D6648 and AASHTO M320.

Aspect 52 provides the binder composition of any one of Aspects 1-51, wherein the binder composition has an m-BBR of −40 to −10° C. as determined following ASTM D6648 and AASHTO M320.

Aspect 53 provides the binder composition of any one of Aspects 1-52, wherein the binder composition has an unaged penetration of 15 to 220 dmm as determined following ASTM D5.

Aspect 54 provides the binder composition of any one of Aspects 1-53, wherein the binder composition has an unaged penetration of 30 to 100 dmm as determined following ASTM D5.

Aspect 55 provides the binder composition of any one of Aspects 1-54, wherein the binder composition has an RTFO penetration of 15 to 220 dmm as determined following ASTM D5.

Aspect 56 provides the binder composition of any one of Aspects 1-55, wherein the binder composition has an RTFO penetration of 30 to 100 dmm as determined following ASTM D5.

Aspect 57 provides the binder composition of any one of Aspects 1-56, wherein the binder composition has an unaged softening point of 35 to 190° C. as determined following ASTM D3461.

Aspect 58 provides the binder composition of any one of Aspects 1-57, wherein the binder composition has an unaged softening point of 40 to 90° C. as determined following ASTM D3461.

Aspect 59 provides the binder composition of any one of Aspects 1-58, wherein the binder composition has an RTFO softening point of 30 to 190° C. as determined following ASTM D3461 and ASTM D2872.

Aspect 60 provides the binder composition of any one of Aspects 1-59, wherein the binder composition has an RTFO softening point of 40 to 90° C. as determined following ASTM D3461 and ASTM D2872.

Aspect 61 provides the binder composition of any one of Aspects 1-60, wherein the binder composition has an RTFO softening point of 45 to 65° C. as determined following ASTM D3461 and ASTM D2872.

Aspect 62 provides the binder composition of any one of Aspects 1-61, wherein the binder composition is an asphalt binder.

Aspect 63 provides the binder composition of any one of Aspects 1-62, wherein the binder composition is a roofing shingle component.

Aspect 64 provides a binder composition comprising:

an oligomerized biorenewable oil that is oligomerized via sulfurization and that is 20 wt % to 45 wt % of the binder composition, wherein oligomer molecules are at least 10 wt % of the oligomerized biorenewable oil (e.g., at least 40 wt %, or at least 60 wt %);

an Asphaltene Additive that is gilsonite, wherein the Asphaltene Additive is 10 wt % to 45 wt % of the binder composition; and

bitumen that is in addition to any bitumen comprised in the Asphaltene Additive and that is 15 wt % to 90 wt % of the binder composition.

Aspect 65 provides an asphalt emulsion comprising:

the binder composition of any one of Aspects 1-64; and

water.

Aspect 66 provides an asphalt pavement comprising:

the binder composition of any one of Aspects 1-64; and

aggregate.

Aspect 67 provides the asphalt pavement of Aspect 66, wherein the asphalt pavement comprises a recycled asphalt pavement, wherein the bitumen in the binder composition includes recycled or aged bitumen, the aggregate comprises aggregate from a recycled asphalt composition, or a combination thereof.

Aspect 68 provides a roofing shingle comprising:

the binder composition of any one of Aspects 1-64; and

a base material.

Aspect 69 provides the roofing shingle of Aspect 68, wherein the base material comprises an organic material, fiberglass, or a combination thereof.

Aspect 70 provides the roofing shingle of Aspect 69, wherein the organic material comprises paper, cellulose, wood fibers, or a combination thereof.

Aspect 71 provides a method of making a binder composition, the method comprising:

forming the binder composition, the binder composition comprising
an oligomerized biorenewable oil that is at least 10 wt % of the binder composition, and
an Asphaltene Additive comprising at least 20 wt % to 100 wt % asphaltenes, wherein the Asphaltene Additive is at least 8 wt % of the binder composition.

Aspect 72 provides the method of claim 71, comprising combining the biorenewable oil and the Asphaltene Additive to form a mixture and combining the mixture and bitumen in addition to any bitumen comprised in the Asphaltene Additive to form the binder composition.

Aspect 73 provides a method of making an asphalt emulsion, the method comprising:

emulsifying the binder composition of any one of Aspects 1-64 and an aqueous phase.

Aspect 74 provides a method of making an asphalt pavement, the method comprising:

combining the binder composition of any one of Aspects 1-64 with an aggregate.

Aspect 75 provides the method of Aspect 74, wherein the asphalt pavement comprises a recycled asphalt pavement, wherein the bitumen in the binder composition comprises recycled or aged bitumen, the aggregate comprises aggregate from a recycled asphalt composition, or a combination thereof.

Aspect 76 provides the method of any one of Aspects 74-75, wherein the asphalt pavement comprises a recycled asphalt pavement, wherein the binder composition comprises bitumen in addition to any bitumen comprised in the Asphaltene Additive that comprises recycled bitumen.

Aspect 77 provides a method of making an asphalt pavement, the method comprising:

combining an aggregate and a binder composition, the binder composition comprising
an oligomerized biorenewable oil that is oligomerized via sulfurization and that is 20 wt % to 45 wt % of the binder composition, wherein oligomer molecules are at least 60 wt % of the oligomerized biorenewable oil (e.g., at least 40 wt %, or at least 60 wt %),
an Asphaltene Additive that is gilsonite, wherein the Asphaltene Additive is 10 wt % to 45 wt % of the binder composition, and
bitumen in addition to any bitumen comprised in the Asphaltene Additive that is 15 wt % to 90 wt % of the binder composition.

Aspect 78 provides a method of making a roofing shingle, the method comprising:

combining the binder composition of any one of Aspects 1-64 with a base material.

Aspect 79 provides a pre-blend for forming the binder composition of any one of Aspects 1-64, the pre-blend comprising:

the oligomerized biorenewable oil; and

the Asphaltene Additive comprising at least 20 wt % to 100 wt % asphaltenes;

wherein the pre-blend is substantially free of bitumen other than any bitumen that is comprised in the Asphaltene Additive.

Aspect 80 provides the binder composition, pre-blend, asphalt emulsions, asphalt pavement, roofing shingle, or methods of making the same of any one or any combination of Aspects 1-79 optionally configured such that all elements or options recited are available to use or select from.

1. A binder composition comprising:
an oligomerized biorenewable oil that is at least 10 wt % of the binder composition; and
an Asphaltene Additive comprising at least 20 wt % to 100 wt % asphaltenes, wherein the Asphaltene Additive is at least 8 wt % of the binder composition.

2. The binder composition of claim 1, wherein low molecular weight and low polarity naphthenic or aromatic molecules, and a saturates fraction, are less than about 30 wt % of the Asphaltene Additive.

3. The binder composition of claim 1, wherein the binder composition comprises bitumen in addition to any bitumen comprised in the Asphaltene Additive.

4. The binder composition of claim 1, wherein the Asphaltene Additive is 8 wt % to 60 wt % of the binder composition, wherein the Asphaltene Additive is gilsonite, uintahite, residuum oil supercritical extract, or a combination thereof.

5. The binder composition of claim 1, wherein the oligomerized biorenewable oil has not been blended with any non-oligomerized oil after oligomerization.

6. The binder composition of claim 1, wherein the oligomerized biorenewable oil is 10 wt % to 80 wt % of the binder composition.

7. The binder composition of claim 1, wherein the binder composition comprises a polymer modifier, wherein the binder composition is modified using the polymer modifier, or a combination thereof.

8. The binder composition of claim 1, wherein the binder composition comprises an acid modifier, wherein the binder composition is modified using the acid modifier, or a combination thereof.

9. The binder composition of claim 1, wherein the binder composition has a high temperature service temperature performance grade of 34 to 122° C. as determined following AASHTO M 320-10, a low temperature service temperature performance grade of −46 to 22° C. as determined following AASHTO M 320-10, or a combination thereof.

10. The binder composition of claim 1, wherein the binder composition has a performance grade as determined following AASHTO M 320-10 of PG 52-34, PG 58-28, PG 58-34, PG 64-22, PG 64-28, PG 70-16, PG 70-22, or PG 76-22.

11. (canceled)

12. (canceled)

13. An asphalt pavement comprising:
the binder composition of claim 1; and
aggregate.

14. A roofing shingle comprising:
the binder composition of claim 1; and
a base material.

15.-20. (canceled)
